(19) United States
(12) Patent Application Publication
(10) Pub. No.: US 2025/0142523 A1
(43) Pub. Date: May 1, 2025

(54) SELECTION OF APPARATUS FOR SIDELINK POSITIONING

(71) Applicant: Lenovo (Singapore) Pte. Limited, Singapore (SG)

(72) Inventors: Hyung-Nam Choi, Ottobrunn (DE); Robin Rajan Thomas, Frankfurt (DE)

(73) Assignee: Lenovo (Singapore) Pte. Limited, Singapore (SG)

(21) Appl. No.: 18/926,100

(22) Filed: Oct. 24, 2024

Related U.S. Application Data
(60) Provisional application No. 63/546,054, filed on Oct. 27, 2023.

(51) Int. Cl. H04W 64/00; H04W 48/20; H04W 92/18

(52) U.S. Cl. CPC H04W 64/00; H04W 48/20; H04W 92/18

(57) ABSTRACT

Various aspects of the present disclosure relate to selection of apparatus for sidelink positioning. A user equipment (UE) (e.g., a sidelink positioning target UE) receives from a first apparatus a first sidelink positioning protocol message including information for selecting a first set of one or more second apparatus for sidelink positioning. The UE can select from the first set of one or more second apparatus, a subset of the one or more second apparatus for sidelink positioning. The UE can transmit, to the first apparatus, a second sidelink positioning protocol message comprising information pertaining to the subset of the one or more second apparatus that can be used for determining a position of the UE.

### RELATED APPLICATION

This application claims priority to U.S. Provisional Application Ser. No. 63/546,054 filed 27 Oct. 2023 entitled “SELECTION OF APPARATUS FOR SIDELINK POSITIONING,” the disclosure of which is incorporated by reference herein in its entirety.

### TECHNICAL FIELD

The present disclosure relates to wireless communications, and more specifically to selection of apparatus for sidelink positioning in wireless communications.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like)) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include functionality to receive, from a first apparatus, a first sidelink positioning protocol message including information for selecting a first set of one or more second apparatus for sidelink positioning; select, from the first set of one or more second apparatus, a subset of the one or more second apparatus for sidelink positioning; and transmit, to the first apparatus, a second sidelink positioning protocol message including information pertaining to the subset of the one or more second apparatus.

In some implementations of the method and apparatuses described herein, at least one processor is configured to cause a UE to select the subset of the one or more second apparatus based at least in part on a determination that a sidelink connection with the subset of the one or more second apparatus is able to be established; the information pertaining to the subset of the one or more second apparatus includes a priority value; the at least one processor is configured to cause the UE to determine whether a sidelink connection with the one or more second apparatus is able to be established based at least in part on the priority value; to select the subset of the one or more second apparatus for sidelink positioning, the at least one processor is configured to cause the UE to: determine that a sidelink connection drops to a first candidate apparatus of the first set of the one or more second apparatus; and perform a reselection of a second candidate apparatus of the first set of the one or more second apparatus; the at least one processor is configured to cause the UE to maintain the selected subset of the one or more second apparatus for sidelink positioning operation; the UE includes a sidelink target UE; the first apparatus includes one or more of a sidelink server UE or a location management function; the subset of the one or more second apparatus includes one or more of a sidelink anchor UE or a sidelink server UE; the at least one processor is configured to cause the UE to maintain a set of inactive sidelink anchor UE that are not currently involved in a sidelink positioning operation; the at least one processor is configured to cause the UE to select the subset of the one or more second apparatus for sidelink positioning based at least in part on the set of inactive sidelink anchor UE

Some implementations of the method and apparatuses described herein may further include receiving, from a first apparatus, a first sidelink positioning protocol message including information for selecting a first set of one or more second apparatus for sidelink positioning; selecting, from the first set of one or more second apparatus, a subset of the one or more second apparatus for sidelink positioning; and transmitting, to the first apparatus, a second sidelink positioning protocol message including information pertaining to the subset of the one or more second apparatus

Some implementations of the method and apparatuses described herein include selecting the subset of the one or more second apparatus based at least in part on a determination that a sidelink connection with the subset of the one or more second apparatus is able to be established; the information pertaining to the subset of the one or more second apparatus includes a priority value; determining whether a sidelink connection with the one or more second apparatus is able to be established based at least in part on the priority value; selecting the subset of the one or more second apparatus for sidelink positioning includes: determining that a sidelink connection drops to a first candidate apparatus of the first set of the one or more second apparatus; and performing a reselection of a second candidate apparatus of the first set of the one or more second apparatus; maintaining the selected subset of the one or more second apparatus for sidelink positioning operation; the UE includes a sidelink target UE; the first apparatus includes one or more of a sidelink server UE or a location management function; the subset of the one or more second apparatus includes one or more of a sidelink anchor UE or a sidelink server UE; maintaining a set of inactive sidelink anchor UE that are not currently involved in a sidelink positioning operation; selecting the subset of the one or more second apparatus for sidelink positioning based at least in part on the set of inactive sidelink anchor UE.

Some implementations of the method and apparatuses described herein may further include functionality to transmit, to a second UE, a first sidelink positioning protocol message including information for selecting a first set of one or more apparatus for sidelink positioning of the second UE; and receive, from the second UE, a second sidelink positioning protocol message including information pertaining to a subset of the one or more apparatus.

In some implementations of the method and apparatuses described herein, the information pertaining to the subset of the one or more apparatus includes a priority value; the second UE includes a sidelink target UE; the first UE includes a sidelink server UE.

Some implementations of the method and apparatuses described herein may further include transmitting, to a second UE, a first sidelink positioning protocol message including information for selecting a first set of one or more apparatus for sidelink positioning of the second UE; and receiving, from the second UE, a second sidelink positioning protocol message including information pertaining to a subset of the one or more apparatus.

In some implementations of the method and apparatuses described herein, the information pertaining to the subset of the one or more apparatus includes a priority value; the second UE includes a sidelink target UE; the first UE includes a sidelink server UE.

Some implementations of the method and apparatuses described herein may further include to receive, from a first apparatus, a first sidelink positioning protocol message including information for selecting a first set of one or more second apparatus for sidelink positioning; select, from the first set of one or more second apparatus, a subset of the one or more second apparatus for sidelink positioning; and transmit, to the first apparatus, a second sidelink positioning protocol message including information pertaining to the subset of the one or more second apparatus.

In some implementations of the method and apparatuses described herein, the at least one controller is configured to cause the processor to select the subset of the one or more second apparatus based at least in part on a determination that a sidelink connection with the subset of the one or more second apparatus is able to be established; the information pertaining to the subset of the one or more second apparatus includes a priority value; the at least one controller is configured to cause the processor to determine whether a sidelink connection with the one or more second apparatus is able to be established based at least in part on the priority value; to select the subset of the one or more second apparatus for sidelink positioning, the at least one controller is configured to cause the processor to: determine that a sidelink connection drops to a first candidate apparatus of the first set of the one or more second apparatus; and perform a reselection of a second candidate apparatus of the first set of the one or more second apparatus; the at least one controller is configured to cause the processor to maintain the selected subset of the one or more second apparatus for sidelink positioning operation; the processor is implemented as part of a sidelink target UE; the first apparatus includes one or more of a sidelink server UE or a location management function; the subset of the one or more second apparatus includes one or more of a sidelink anchor UE or a sidelink server UE; the at least one controller is configured to cause the processor to maintain a set of inactive sidelink anchor UE that are not currently involved in a sidelink positioning operation; the at least one controller is configured to cause the processor to select the subset of the one or more second apparatus for sidelink positioning based at least in part on the set of inactive sidelink anchor UE.

Some implementations of the method and apparatuses described herein may further include to transmit, to a first UE, a first sidelink positioning protocol message including information for selecting a first set of one or more apparatus for sidelink positioning of a second UE; and receive, from the first UE, a second sidelink positioning protocol message including information pertaining to a subset of the one or more apparatus.

In some implementations of the method and apparatuses described herein, the information pertaining to the subset of the one or more apparatus includes a priority value; the first UE includes a sidelink target UE; the processor is implemented as part of a sidelink server UE.

Some implementations of the method and apparatuses described herein may further include to transmit, to a first UE, a first sidelink positioning protocol message including information for selecting a first set of one or more second UE for sidelink positioning of the first UE; and receive, from the first UE, a second sidelink positioning protocol message including information pertaining to a subset of the one or more second UE.

In some implementations of the method and apparatuses described herein, the information pertaining to the subset of the one or more second UE includes a priority value; the network entity includes a location management function; the subset of the one or more second UE includes one or more of a sidelink anchor UE or a sidelink server UE; to maintain a set of inactive sidelink anchor UE that are not currently involved in a sidelink positioning operation.

Some implementations of the method and apparatuses described herein may further include transmitting, to a first UE, a first sidelink positioning protocol message including information for selecting a first set of one or more second UE for sidelink positioning of the first UE; and receiving, from the first UE, a second sidelink positioning protocol message including information pertaining to a subset of the one or more second UE.

In some implementations of the method and apparatuses described herein, the information pertaining to the subset of the one or more second UE includes a priority value; the network entity includes a location management function; the subset of the one or more second UE includes one or more of a sidelink anchor UE or a sidelink server UE; maintaining a set of inactive sidelink anchor UE that are not currently involved in a sidelink positioning operation.

### BRIEF DESCRIPTION OF THE DRAWINGS

FIG. 1 illustrates an example of a wireless communications system in accordance with aspects of the present disclosure.

FIG. 2 illustrates an example of a message transfer procedure 200.

FIG. 3 illustrates an exemplary LCS architecture 300.

FIG. 4 illustrates an example procedure 400 for regulatory location service for non-roaming scenario.

FIG. 5 illustrates an example procedure 500 for another type of location service.

FIG. 6 illustrates a scenario 600 for sidelink communication and discovery.

FIG. 7 illustrates an example scenario 700 for configuration of sidelink (SL) positioning reference signal (PRS) resources in a SL bandwidth part (BWP).

FIG. 8 illustrates an example procedure 800 for a message flow for network-based SL positioning.

FIG. 9 illustrates an example procedure 900 for UE-only based SL positioning.

FIG. 10 illustrates an example procedure 1000 in accordance with aspects of the present disclosure.

FIG. 11 illustrates an example procedure 1100 in accordance with aspects of the present disclosure.

FIG. 12 illustrates an example of a UE 1200 in accordance with aspects of the present disclosure.

FIG. 13 illustrates an example of a processor 1300 in accordance with aspects of the present disclosure.

FIG. 14 illustrates an example of a NE (network element) 1400 in accordance with aspects of the present disclosure.

FIG. 15 illustrates a flowchart of a method 1500 in accordance with aspects of the present disclosure.

FIG. 16 illustrates a flowchart of a method 1600 in accordance with aspects of the present disclosure.

FIG. 17 illustrates a flowchart of a method 1700 in accordance with aspects of the present disclosure.

### DETAILED DESCRIPTION

Sidelink (SL) positioning has been developed to determine the position of a UE by using SL positioning methods over the PC5 interface and in various coverage scenarios, e.g., in-coverage, partial coverage and out-of-coverage scenarios, and for PC5-only-based and joint PC5-Uu-based operation scenarios. For SL positioning of a Target UE, other UE such as Anchor and Server UE can be subject to discovery and selection in accordance with certain conditions such as operation scenario, type of location request, positioning mode, etc. For each selected Anchor or Server UE, the Target UE can establish a unicast SL connection in order to perform SL positioning with the selected UE.

However, due to the dynamic nature of SL positioning the set of selected Anchor UE and/or Server UE may vary during an ongoing SL positioning session such that an Anchor UE and/or Server UE discovery and selection process may be initiated frequently by a Target UE. This may result in additional delay for performing SL positioning, and thus potential degradation in the performance of location estimation. Another drawback of initiating frequent Anchor UE and/or Server UE discovery and selection processes is a resulting additional signaling overhead that is originated from the transmission and/or reception of discovery messages and SL connection establishment between the involved UE.

Accordingly, aspects of the present disclosure enable improvement of Anchor UE and Server UE discovery and selection processes, such as part of SL positioning sessions. For instance, regarding discovery and selection of Anchor UE, both Target UE and location server (e.g., LMF, Server UE, etc.) maintain a set of active Anchor UE associated to an ongoing SL positioning session. Further, sidelink positioning protocol (SLPP) messages (Active Anchor UE Set Config, Active Anchor UE Set Request, etc.) are defined for exchanging information related to the Active Anchor UE set between the Target UE and location server. A location server may also send a pre-selected set of candidate Anchor UE to the Target UE. The location server may compile this pre-selected set based on available information. Based at least in part on reception of a pre-selected set of candidate Anchor UE the Target UE may initiate SL discovery and SL connection establishment with the set of candidate Anchor UE. A Target UE can perform selection of the Anchor UE for SL positioning. According to the order of occurrence of the Anchor UE in the set (e.g., based on a priority or ranking) the Target UE can select an Anchor UE with which it can successfully establish an SL connection.

Further, Target UE and location server may also maintain a set of inactive Anchor UE (e.g. Anchor UE) that were discovered but are currently not involved in a SL positioning operation. The Target UE may use this information when a new Anchor UE discovery and selection process is to be initiated for an ongoing SL positioning session. The location server may use this information for sending a pre-selected set of candidate Anchor UE to the Target UE.

Regarding discovery and selection of Server UE in accordance with aspects of the present disclosure, based on available information an LMF can preselect a set of candidate Server UE and send the set to the Target UE. One or more candidate Server UE in the set can be associated with a priority. Alternatively or additionally, the Target UE may perform ranking of the candidate Server UE by measuring the reference signal received power (RSRP) for each UE in the set. The Target UE can perform selection of the Server UE for SL positioning by selecting the first Server UE with which it can successfully establish an SL connection and sends then a message back to inform the LMF concerning the selected Server UE. In implementations if during an ongoing SL positioning session an established SL connection with the selected Server UE drops a Target UE can perform Server UE reselection based on a stored set of candidate Server UE. Further, Target UE and LMF can maintain the set of candidate Server UE. During an ongoing SL positioning session the LMF may generate and send updates of the candidate Server UE set to the Target UE.

By utilizing the described techniques, signaling overhead and latency in sidelink positioning can be decreased and accuracy of device positioning in sidelink positioning can be increased.

Aspects of the present disclosure are described in the context of a wireless communications system.

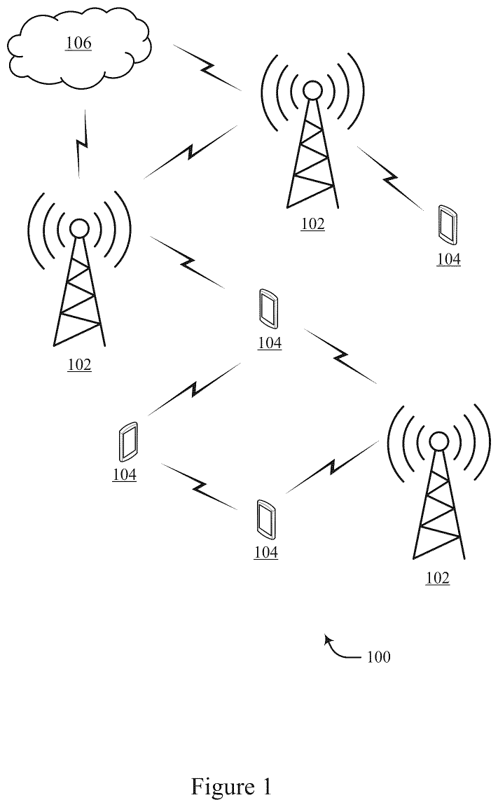

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be an NR network, such as a 5G network, a 5G-Advanced (5G-A) network, or a 5G ultrawideband (5G-ultra wideband (UWB)) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UE 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UE 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UE 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signaling bearers, etc.) for the one or more UE 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UE 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UE 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UE 104 may support different resource structures. For example, the NEs 102 and the UE 104 may support different frame structures. In some implementations, such as in 4G, the NEs 102 and the UE 104 may support a single frame structure. In some other implementations, such as in 5G and among other suitable radio access technologies, the NEs 102 and the UE 104 may support various frame structures (i.e., multiple frame structures). The NEs 102 and the UE 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UE 104 may perform wireless communications over one or more of the operating frequency bands. In some implementations, FR1 may be used by the NEs 102 and the UE 104, among other equipment or devices for cellular communications traffic (e.g., control information, data). In some implementations, FR2 may be used by the NEs 102 and the UE 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UE 104 are operable to implement various aspects of the techniques described with reference to the present disclosure. For example, a UE 104 (e.g., a SL positioning target UE) receives, from a first apparatus (e.g., a sidelink server UE, an LMF, etc.) a first sidelink positioning protocol message including information for selecting a first set of one or more second apparatus for sidelink positioning. The second apparatus can include a sidelink anchor UE, a sidelink server UE, etc. The UE 104 can select from the first set of one or more second apparatus, a subset of the one or more second apparatus for sidelink positioning and transmit, to the first apparatus, a second sidelink positioning protocol message comprising information pertaining to the subset of the one or more second apparatus. The subset of the one or more second apparatus can be used to obtain information pertaining to a position of the UE 104.

Sidelink (SL) positioning has been specified in Rel-18 NR to support the target accuracy for SL positioning as listed in Table 1, below. SL positioning can be applied for a variety of use cases such as V2X, public safety, industrial internet of things (IIoT), and commercial use cases. A goal of SL positioning is to determine a position of a UE by using SL positioning methods such as SL-round trip time (RTT), SL-angle of arrival (AoA and SL-time difference of arrival (TDOA). SL positioning can use SL PRS that is transmitted over the PC5 interface and can be supported in multiple coverage scenarios (e.g., in-coverage, partial coverage, and out-of-coverage scenarios) and for PC5-based (e.g., UE-only based) and joint PC5-Uu-based (e.g., network-based) operation scenarios. For exchanging SL positioning related information between UE over the PC5 interface and between UE and LMF over the Uu interface a protocol denoted as SLPP is implemented. The following functionalities can be supported by SLPP: SL Positioning Capability Transfer, SL Positioning Assistance Data exchange, SL Location Information Transfer, Error handling, Abort.

The cast types that have been considered for SLPP signaling over the PC5 interface include unicast, groupcast and broadcast, but unicast/one-to-one operation can be assumed as baseline for exchange of SLPP signaling between UE. For SL positioning of a Target UE, other UE such as Anchor and Server UE are to be discovered and selected in accordance with the operation scenario, type of location request and positioning mode, such as follows:

### (1) In Network-Based SL Positioning Operation Scenarios:

For SL-mobile originated (MO)-location request (LR)/SL-mobile terminated (MT)-LR and UE-assisted positioning mode: the Target UE performs Anchor/Server UE discovery and Anchor UE selection, and the LMF may select one Server UE for the location calculation. The SL positioning capable LMF may decide to offload the location calculation to a separate Server UE, e.g., due to load reasons.
For SL-MO-LR/SL-MT-LR and UE-based positioning mode: the Target UE performs Anchor UE discovery and selection.

### (2) In UE-Only Based SL Positioning Operation Scenarios:

For SL-MO-LR and UE-assisted positioning mode (e.g., the Target UE has no Server UE functionality): the Target UE performs Anchor/Server UE discovery and selection, and the selected separate Server UE performs the location calculation.
For SL-MT-LR and UE-assisted positioning mode: the Target UE performs Anchor UE discovery and selection, and the separate Server UE performs the location calculation.
For SL-MO-LR/SL-MT-LR and UE-based positioning mode (i.e. the Target UE has Server UE functionality): the Target UE performs Anchor UE discovery and selection and performs the location calculation itself.

For each selected Anchor and/or Server UE, the Target UE can establish a unicast SL connection in order to perform SL positioning with the selected UE. However, due to the dynamic nature of SL positioning (e.g. mobility of the involved UE, varying availability of SL PRS resources, radio channel conditions and SL positioning processing capabilities of the involved UE) the set of selected Anchor/Server UE may vary during an ongoing SL positioning session, so that the Anchor/Server UE discovery and selection process may be initiated frequently by the Target UE. But then this may result in additional delay for performing SL positioning, and thus potential degradation in the performance of location estimation. Another drawback of initiating frequent Anchor/Server UE discovery and selection process is the resulting additional signaling overhead that is originated from the transmission/reception of discovery messages and SL connection establishment between the involved UE.

In network-based SL positioning operation scenarios one way to reduce the frequent initiation of Anchor/Server UE discovery and selection process is to enable the LMF to provide a Target UE with assistant information about candidate Anchor/Server UE to discover and select for SL positioning. Further, in UE-only based SL positioning operation scenarios a way to reduce the frequent initiation of Anchor UE discovery and selection process is to enable the Server UE to provide a Target UE with assistant information about candidate Anchor UE to discover and select for SL positioning. Implementations for such solutions for SL positioning and are provided in this disclosure.

TABLE 1
Target accuracy parameters for SL positioning

| SL Positioning | | | | |
|---|---|---|---|---|
| KPIs | V2X | Public Safety | IIoT | Commercial |
| Horizontal | Set A: 1.5 m for | 1 m for 90% of UE | Set A: 1 m for | 1 m for 90% of |
| Positioning | 90% of UE | (absolute or | 90% of UE | UE (absolute or |
| Accuracy | (absolute or | relative) | (absolute or | relative) |
| | relative) | | relative) | |
| | Set B: 0.5 m for | | Set B: 0.2 m for | |
| | 90% of UE | | 90% of UE | |
| | (absolute or | | (absolute or | |
| | relative) | | relative) | |
| Vertical | Set A: 3 m for | 2 m (absolute or | Set A: 1 m for | 2 m for 90% of |
| Positioning | 90% of UE | relative between 2 | 90% of UE | UE (absolute or |
| Accuracy | (absolute or | UE) for 90% of UE | (absolute or | relative) |
| | relative) | | relative) | |
| | Set B: 2 m for | 0.3 m (relative | Set B: 0.2 m for | |
| | 90% of UE | positioning change | 90% of UE | |
| | (absolute or | for 1 UE) for 90% | (absolute or | |
| | relative) | of UE | relative) | |
| Relative Speed | — | Up to 30 km/h | Up to 30 km/h | Up to 30 km/h |

| | |
|---|---|
| Angle | Set A: Y = ±15° for 90% of the UE |
| Accuracy | Set B: Y = ±8° for 90% of the UE |

Note:
In Table 1 “Set A” and “Set B” refer to the categorization of parameters into two sets.

Regarding support of positioning in NR, in Rel-15 only Cell-identifier (ID) and RAT-independent positioning methods (e.g. global navigation satellite system (GNSS)) are supported. To meet the positioning requirements for regulatory (e.g. emergency services) and commercial use cases (e.g. IIoT) as listed in Table 2 below, RAT-dependent (for both FR1 and FR2) and RAT-independent positioning methods (such as precise point positioning (PPP) and real-time kinematic (RTK)) have been specified in Rel-16. Table 3 shows the list of RAT-dependent positioning methods which were specified in Rel-16.

TABLE 2
Positioning requirements for regulatory and commercial use cases

| Positioning | | |
|---|---|---|
| requirement | Regulatory use cases | Commercial use cases |
| Horizontal | <=50 m for 80% of UE | <3 m for 80% of UE in |
| positioning | | indoor deployment |
| error (accuracy) | | scenarios |
| | | <10 m for 80% of UE in |
| | | outdoor deployments |
| | | scenarios |
| Vertical positioning | <5 m for 80% of UE | <3 m for 80% of UE in |
| error (accuracy) | | indoor deployment |
| | | scenarios |
| | | <3 m for 80% of UE in |
| | | outdoor deployment |
| | | scenarios |
| End to end latency | <30 seconds | |
| and Time To First | | |
| Fix (TTFF) | | |
| End to end latency | | <1 s |

TABLE 3
RAT-dependent positioning methods

| | | UE-assisted, LMF- | NG-RAN node |
|---|---|---|---|
| Method | UE-based | based | assisted |
| DL-TDOA | Yes | Yes | No |
| DL-AoD | Yes | Yes | No |
| Multi-RTT | No | Yes | Yes |
| NR E-CID | No | Yes | Yes |
| UL-TDOA | No | No | Yes |
| UL-AoA | No | No | Yes |

To comply with positioning parameters for commercial use cases and specifically IIoT use cases as listed in Table 4, further enhancements for NR positioning have been specified in Rel-17 such as: Improvements of positioning accuracy and latency (uplink (UL)-AoA enhancements, downlink (DL)-angle of departure (AoD enhancements, Preconfigured measurement gap, Preconfigured PRS processing window etc.); Improvements of network efficiency (On-Demand PRS transmission); Improvement of device efficiency (Positioning in RRC_INACTIVE); Providing high integrity and reliability requirements (GNSS integrity); Enhancements of A-GNSS positioning.

TABLE 4
Positioning requirements for commercial and IIoT use cases

| Positioning requirement | Commercial use cases | IIoT use cases |
|---|---|---|
| Horizontal position | (<1 m) for 90% of UE | (<0.2 m) for 90% |
| accuracy | | of UE |
| Vertical position accuracy | (<3 m) for 90% of UE | (<1 m) for 90% |
| | | of UE |
| End to end latency for | (<100 ms) | (<100 ms, in the |
| position estimation | | order of 10 ms |
| | | is desired) |
| PHY latency for position | (<10 ms) | (<10 ms) |
| estimation | | |

In the 5GS architecture that is applicable to positioning of a UE either the UE itself or the location server determines the UE position depending on the applied positioning method. For exchanging the positioning related information (e.g. location related measurements, location estimates, assistance data), LTE positioning protocol (LPP) as specified in technical specification (TS) 37.355 is used point-to-point between the location server and the UE. In LPP the following message types are supported: Request Capabilities; Provide Capabilities; Request Assistance Data; Provide Assistance Data; Request Location Information; Provide Location Information; Abort; Error.

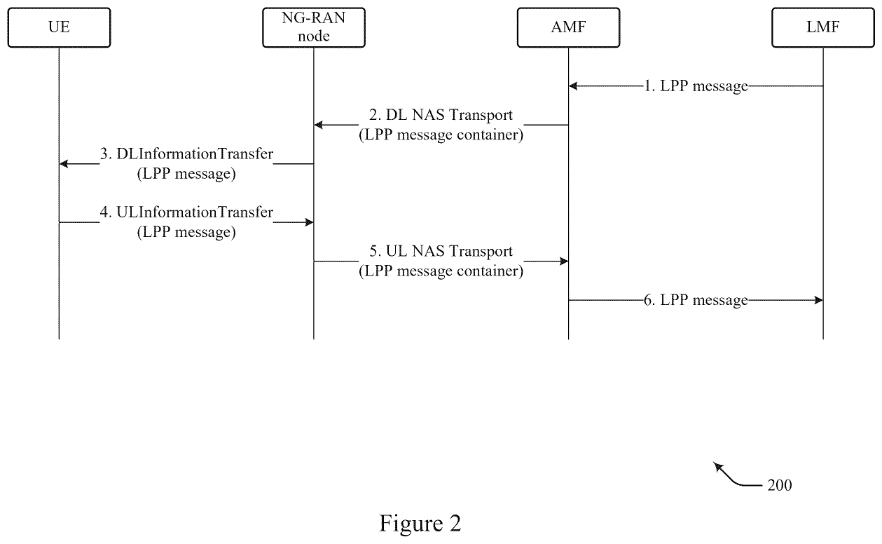

FIG. 2 illustrates an example of a message transfer procedure 200. The procedure 200, for instance, illustrates an example LPP message transfer between an LMF (e.g., location server) and a UE. LPP messages are carried as transparent PDUs across intermediate network interfaces using the appropriate protocols.

Step 1: The LMF sends an LPP message to an AMF. The LPP message may be the Request Capabilities message to request the UE to send its positioning capabilities.

Step 2: The AMF transports the received LPP message to an NG-RAN node by including the LPP message into the LPP message container of the DL NAS Transport message.

Step 3: The NG-RAN node transports the received LPP message container to the UE by including the LPP message container into the radio resource control (RRC) DLInformationTransfer message as specified in TS 38.331.

Step 4: Upon receiving the Request Capabilities message, the UE generates the Provide Capabilities message as response. The UE sends then the Provide Capabilities message to the NG-RAN node by including the LPP message into the RRC ULInformationTransfer message as specified in TS 38.331.

Step 5: The NG-RAN node transports the LPP message received from the UE to the AMF by including the LPP message into the LPP message container of the UL NAS Transport message.

Step 6: The AMF extracts the LPP message from the received NAS message/LPP message container and sends it to the LMF.

The Location Services (LCS) feature in 3GPP provides mechanisms to support mobile location services for operators, subscribers and third-party service providers. Examples of location-based services include emergency services, tracking services, location-based information services (e.g., navigation, city sightseeing, location dependent content broadcast, mobile yellow pages, etc.). The location information may be requested by and reported to a client (e.g., application) associated with a UE, or by a client within or attached to the 5GC.

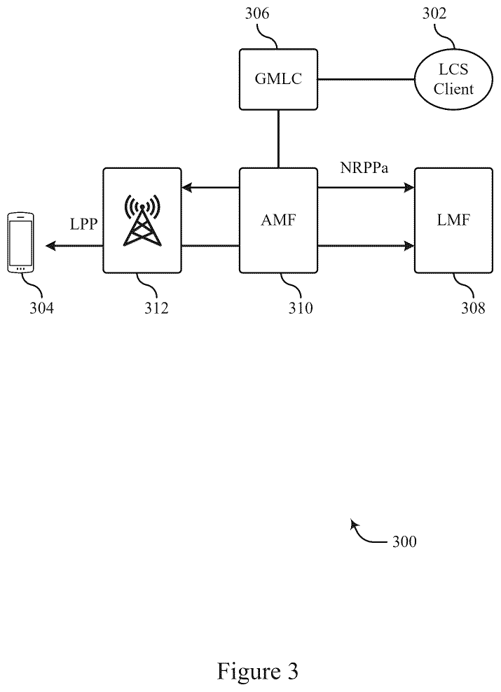

FIG. 3 illustrates an exemplary LCS architecture 300. In the LCS architecture 300 an external LCS client 302 requests the 5GC for the current location of a Target UE 304. Further, the relation of the LCS entities is shown.

The external LCS Client 302 interacts with a gateway mobile location center (GMLC) 306 for the purpose of obtaining location information for one or more (Target) UE 304. The LCS Client 302 may reside in a UE and may be implemented as hardware and/or software, e.g., application. Examples of the LCS client 302 include 911 emergency dispatch center (public safety answering point (PSAP)), map application, etc.

The GMLC 306 is the first node the external LCS client 302 accesses in a public land mobile network (PLMN) and works as a location server to an external application for location information. An LMF 308 manages the overall co-ordination and scheduling of resources required for the location of a UE that is registered with or accessing 5GC. It also calculates or verifies a final location and any velocity estimate and may estimate the achieved accuracy. The LMF 308 processes the location services request which may include transferring assistance data to the Target UE 304 to assist with UE-based and/or UE-assisted positioning and/or may include positioning of the Target UE 304. The LMF 308 then returns the position estimate for a UE back to an AMF 310. In the case of a location service requested by an entity other than the AMF 310 (e.g. a GMLC or UE), the AMF 310 returns the location result to this entity. In C-plane the LMF 308 works as location server.

The AMF 310 contains functionality responsible for managing positioning for a Target UE 304 for location requests. The AMF 310 receives a request for some location services associated with a particular Target UE 304 from another entity (e.g. GMLC or UE) or the AMF 310 itself decides to initiate some location service on behalf of a particular Target UE 304 (e.g. for an emergency call from the UE). The AMF 310 then sends a location services request to an LMF 308.

The NG-RAN node 312 (e.g. gNB) is involved in the handling of various positioning procedures including positioning of a Target UE 304, provision of location related information not associated with a particular Target UE 304 and transfer of positioning messages between an AMF 310 or LMF 308 and a Target UE 304.

The Target UE 304 is the UE whose position (absolute or relative) is to be obtained by the network or by the UE itself. NRPPa is the C-plane radio network layer signaling protocol between a NG-RAN node 312 (gNB) and the LMF 308. LPP is a point-to-point positioning protocol that supports positioning and location related services for a Target device. In C-plane, LPP is terminated between a Target UE 304 and an LMF 308.

The following types of location requests are specified in 3GPP:

Network Induced Location Request (NI-LR): A serving AMF for a UE initiates localization of the UE for a regulatory service (e.g. an emergency call from the UE) or for verification of a UE location (country or international area) for NR satellite access.

Mobile Terminated Location Request (MT-LR): An LCS client external to or internal to a serving PLMN sends a location request to the PLMN for the location of a Target UE.

Mobile Originated Location Request (MO-LR): A UE sends a request to a serving PLMN for location related information for the UE itself.

Immediate Location Request: An LCS client sends or instigates a location request for a Target UE (or group of Target UE) and expects to receive a response containing location information for the Target UE (or group of Target UE) within a short time period which may be specified using LCS QoS. In regulatory cases, one or more responses of the Target UE location information can be expected. An immediate location request may be used for an NI-LR, MT-LR or MO-LR.

Deferred Location Request: An LCS client sends a location request to a PLMN for a Target UE (or group of Target UE) and expects to receive a response containing the indication of event occurrence and location information if requested for the Target UE (or group of Target UE) at some future time (or times), which may be associated with specific events associated with the Target UE (or group of Target UE). Deferred location requests are supported only for an MT-LR.

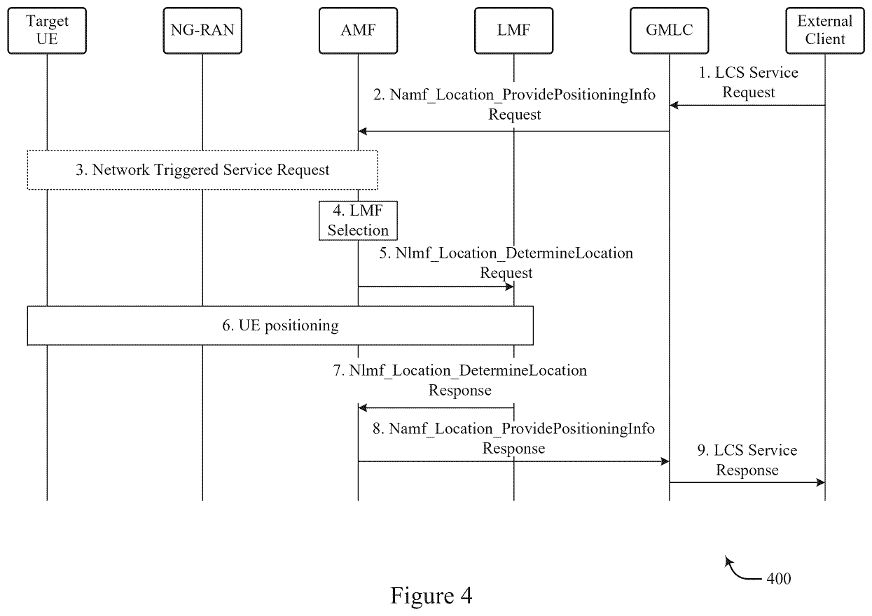

FIG. 4 illustrates an example procedure 400 for regulatory location service for non-roaming scenarios. The procedure 400, for instance, represents a 5GC-MT-LR procedure for the regulatory location service for non-roaming scenario as specified in TS 23.273. In the procedure 400 an external LCS client requests the 5GC for the current location of a Target UE. The target UE can be identified using a subscription permanent identifier (SUPI) or generic public subscription identifier (GPSI).

Step 1: The external LCS client sends a request to the GMLC for the current location of the Target UE. The request includes amongst other the requested LCS QoS.

Step 2: The GMLC sends the Namf_Location_ProvidePositioningInfo Request to the AMF to request the current location of the target UE.

Step 3: If the target UE is in control management (CM)-IDLE state, the AMF initiates a network triggered Service Request procedure to establish a signaling connection with the target UE.

Step 4: The AMF selects an LMF based on the available information (e.g. requested LCS QOS, LMF capabilities, LMF load, LMF location) or based on AMF local configuration (if AMF is configured locally with a mapping table of UE identity and LMF address).

Step 5: The AMF sends the Nlmf_Location_DetermineLocation Request to the selected LMF to request the current location of the target UE. The request includes amongst other the requested LCS QoS and the UE positioning capability if available.

Step 6: The LMF performs positioning procedures and determines the geographical location of the target UE.

Step 7: The LMF returns the Nlmf_Location_DetermineLocation Response towards the AMF to return the current location of the target UE, e.g. the location estimate and accuracy, and may include information about the positioning method and the timestamp of the location estimate.

Step 8: The AMF returns the Namf_Location_ProvidePositioningInfo Response towards the GMLC to return the current location of the target UE.

Step 9: The GMLC sends the location service response including the location information of the target UE to the external client.

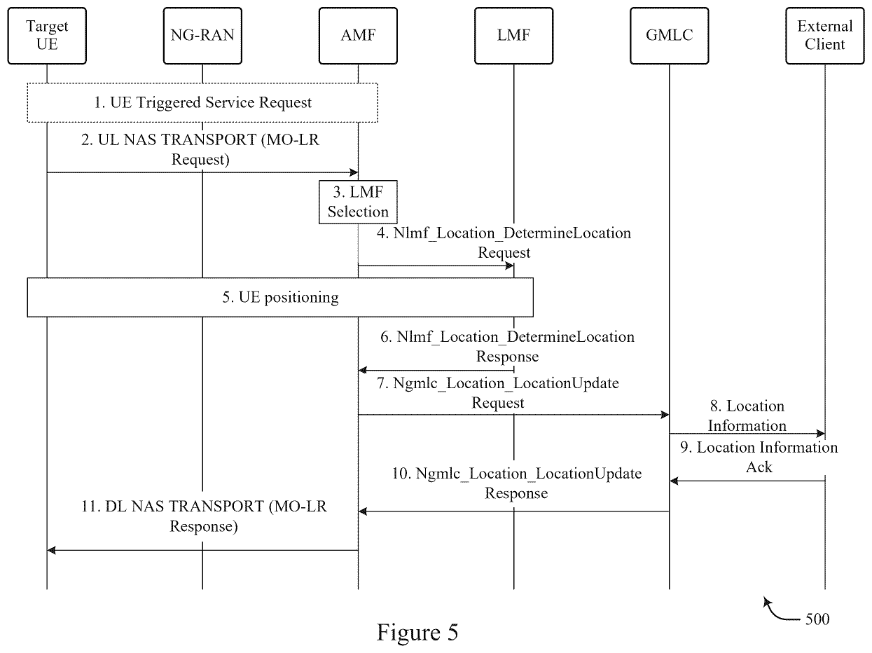

FIG. 5 illustrates an example procedure 500 for another type of location service. The procedure 500, for instance, represents an example 5GC-MO-LR procedure as specified in TS 23.273 where a target UE requests the serving PLMN to obtain the location of itself or provide positioning assistance data. An LCS client, for instance, resides in the target UE and initiates the MO-LR.

Step 1: If the UE is in CM-IDLE state, UE instigates the UE triggered Service Request procedure in order to establish a signaling connection with the AMF.

Step 2: The UE sends an MO-LR Request message included in a UL NAS TRANSPORT message to the AMF. Different types of location services can be requested: location estimate of the UE, location estimate of the UE to be sent to an LCS client, or positioning assistance data. If the UE is requesting its own location or that its own location be sent to an LCS client (e.g. for using a location-based service), this message carries the requested LCS QOS information (e.g. accuracy, response time). If the UE is requesting that its location be sent to an LCS client, the message also includes the identity of the LCS client and the address of the GMLC through which the LCS client should be accessed. If the UE is instead requesting positioning assistance data, the embedded LPP message specifies the type of assistance data and the positioning method for which the assistance data applies.

Step 3: The AMF selects an LMF based on the available information (e.g. requested LCS QOS, LMF capabilities, LMF load, LMF location) or based on AMF local configuration (if AMF is configured locally with a mapping table of UE identity and LMF address).

Step 4: The AMF sends the Nlmf_Location_DetermineLocation Request to the selected LMF. The request includes amongst other an indication whether a location estimate, or positioning assistance data is requested.

Step 5: If the UE is requesting its own location, the LMF performs positioning procedures and determines the geographical location of the UE. If the UE is instead requesting positioning assistance data, the LMF transfers this data to the UE.

Step 6: When a location estimate best satisfying the requested LCS QoS has been obtained or when the requested location assistance data has been transferred to the UE, the LMF returns the Nlmf_Location_DetermineLocation Response towards the AMF. The response includes the location estimate, its age and accuracy. If the UE is requesting positioning assistance data, steps 7 to 11 can be skipped.

Step 7: If the location estimate was successfully obtained, the AMF sends the Ngmlc_Location_LocationUpdate Request to the GMLC. The request carries the identity of the UE, the event causing the location estimate (5GC-MO-LR) and the location estimate, its age and obtained accuracy indication. In addition, the request includes the identity of the LCS Client.

Step 8: The GMLC transfers the Location Information message to the LCS client, carrying the identity of the UE, the event causing the location estimate (5GC-MO-LR) and the location estimate in accordance with the LCS QoS requested by the UE.

Step 9: The LCS Client sends the GMLC the Location Information Ack message signaling that the location estimate of the UE has been received successfully.

Step 10: The GMLC sends a Ngmlc_Location_LocationUpdate Response to AMF to acknowledge the successful reception of the location estimate by the LCS Client.

Step 11: The AMF sends an MO-LR Response message included in a DL NAS TRANSPORT message. If the UE is requesting its own location, the response carries any location estimate requested by the UE and the timestamp of the location estimate (if available) including the indication received from LMF whether the obtained location estimate satisfies the requested accuracy or not, or an indicator whether a location estimate was successfully transferred to the identified LCS client.

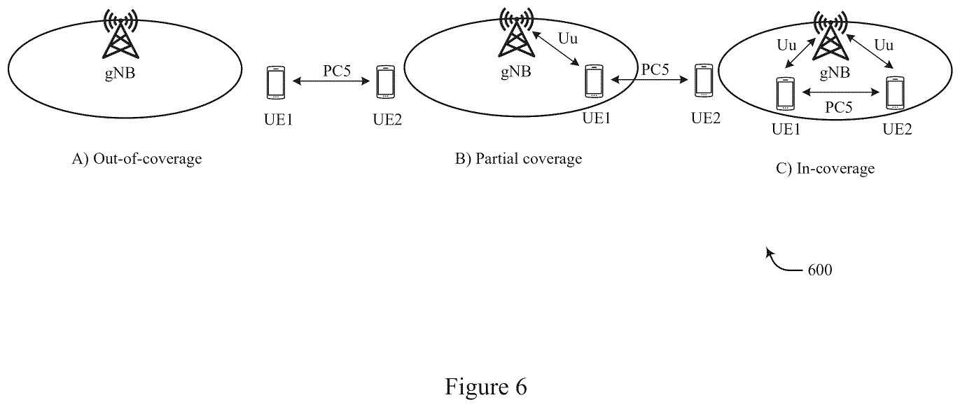

FIG. 6 illustrates a scenario 600 for sidelink communication and discovery. Regarding NR sidelink communication and discovery, the feature of SL communication and discovery was introduced in Rel-16 NR to support V2X and non-V2X services. The interface used for SL communication (transmission/reception of user traffic) and discovery between two UE in proximity is denoted as PC5. Table 5 (below) and the scenario 600 indicate scenarios which are supported for SL communication and discovery where UE1 and UE2 are located in-coverage (IC), partial coverage (PC) and out-of-coverage (OOC) of a cell.

TABLE 5
Sidelink communication and discovery scenarios

| # | Coverage scenario | UE1 | UE2 |
|---|---|---|---|
| A | Out-of-coverage | Out-of-coverage | Out-of-coverage |
| B | Partial coverage | In-coverage | Out-of-coverage |
| C | In-coverage | In-coverage | In-coverage |

The transmission and reception of user traffic over the PC5 interface is supported for unicast, groupcast and broadcast transmission. The transmission and reception of signaling traffic over the PC5 interface is supported for unicast transmission. An SL communication over PC5 is defined as a logical connection between two UE and is identified by a pair of Source and Destination Layer-2 IDs. Source and Destination Layer-2 IDs identify the source and the target of the SL communication, respectively. For a cast type a corresponding pair of a Source Layer-2 ID and a Destination Layer-2 ID can be used. The Layer-2 IDs can be transmitted in the medium access control (MAC) subheader associated with the SL-SCH.

To enable SL communication between UE in proximity a SL discovery procedure may be performed by the UE. In case of the Proximity-based Services (ProSe) feature a separate SL discovery procedure can be used by UE to discover or to be discovered by other UE in proximity. For instance, a UE that wants to discover other UE in proximity transmits a discovery message over PC5. Other UE in proximity can monitor the discovery message and if they want to be discovered they can respond with a discovery response message. After discovery the UE can establish an SL communication connection with each of the UE which responded.

SL discovery messages and SL communication user traffic can be sent on the same physical sidelink shared channel (PSSCH) but using different SL resources. Depending on the use case and type of device (e.g. vehicle, sensor, etc.) the range for SL communication and discovery may vary from 50 m up to 1000 m. More details to NR sidelink communication and discovery can be found in TS 23.304.

Regarding SL PRS resource configuration and allocation, SL positioning can be based on SL PRS that is transmitted over the PC5 interface. An SL PRS resource is a pseudo-random sequence that is mapped to time-frequency resources (pairs of OFDM symbol, subcarrier) within a slot of a radio frame used for SL PRS transmission. Multiple SL PRS resources can be configured within an SL BWP by means of a number of resource pools. A resource pool consists of a number of contiguous PRBs and contiguous or non-contiguous slots. In frequency domain a resource pool is further divided into a number of contiguous subchannels, where a subchannel consists of a group of N consecutive PRBs in a slot. A subchannel represents the smallest unit for SL data transmission or reception. Furthermore, an SL PRS resource pool can be configured as a shared resource pool or as a dedicated resource pool. A shared resource pool can be used for transmission of both SL PRS and PSSCH whereas a dedicated resource pool can be used only for transmission of SL PRS.

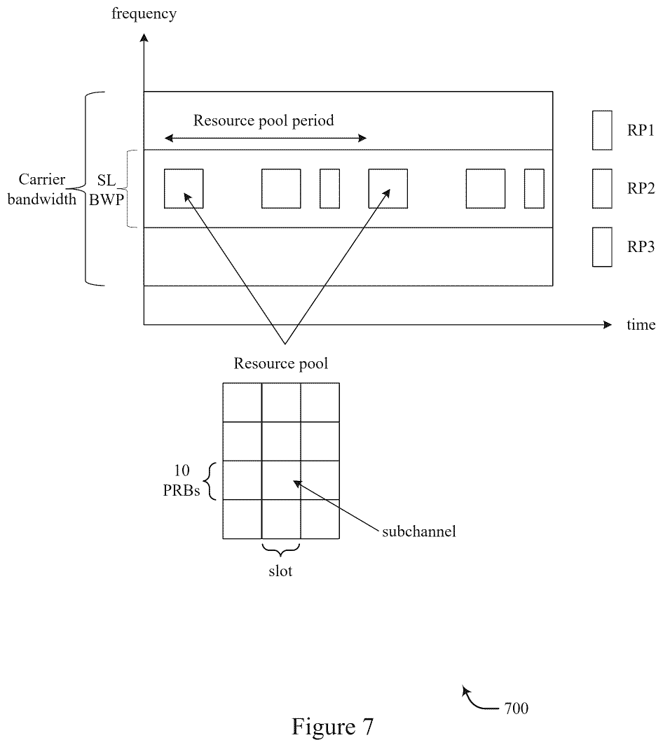

FIG. 7 illustrates an example scenario 700 for configuration of SL PRS resources in a SL BWP. For instance, the scenario 700 illustrates an example configuration of SL PRS resources in an SL BWP. In the scenario 700 3 resource pools for SL PRS are configured within the SL BWP (RP1 to RP3) and the configuration of each resource pool is repeated in time with a given periodicity. For the resource pool RP1, 12 subchannels are defined and each subchannel consists of a group of 10 consecutive PRBs in a slot.

Regarding resource allocation of SL PRS the following schemes can be supported:

Scheme 1 refers to network-controlled SL PRS resource allocation where the gNB manages and schedules the transmission of SL PRS resources. According to this scheme a UE that is to transmit SL PRS sends a request for specific SL PRS resource characteristics/SL-PRS resource configuration to the gNB and receives an SL-PRS resource allocation signaling from gNB through a dynamic grant (provided via downlink control information (DCI)), configured grant type 1 (provided via RRC) or configured grant type 2 (provided via physical downlink control channel (PDCCH)). The request from UE may be sent to gNB via L2 MAC control element (CE) or RRC message.

Scheme 2 refers to UE autonomous SL PRS resource allocation where the UE autonomously selects the SL PRS resources for transmission. According to this scheme the UE first defines a selection window (consisting of number of slots) and identifies candidate SL PRS resources within the selection window. Afterwards the UE senses the identified candidate SL PRS resources during a defined sensing window (consisting of number of slots) to determine which of the SL PRS resources are available. Finally, the UE selects randomly an SL PRS resource among the set of available SL PRS resources. SL PRS transmission can be triggered either by the UE itself or a UE-A can request a UE-B to transmit SL-PRS (either by L1 sidelink control information (SCI) or L2 MAC CE).

Scheme 1 is intended for in-coverage and partial coverage scenarios, whereas Scheme 2 is intended for out-of-coverage scenarios. A UE can be configured via broadcast signaling (SIB12) or dedicated signaling (RRCReconfiguration message) to perform resource allocation Scheme 1 and/or Scheme 2, applicable to all resource pools (dedicated or shared resource pools).

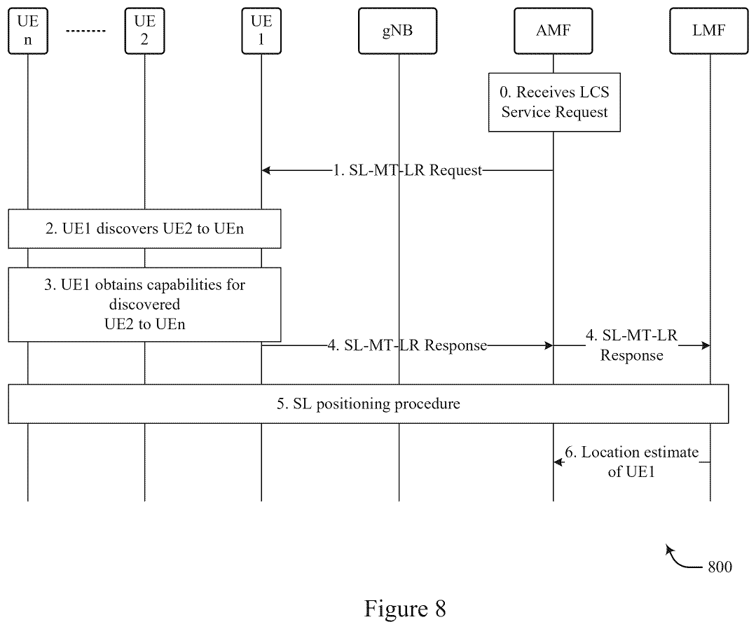

FIG. 8 illustrates an example procedure 800 for a message flow for network-based SL positioning. The procedure 800, for instance, represents an example message flow for an SL-MT-LR procedure where the network is involved and in which the absolute location of a UE1 is to be determined by using SL PRS that is transmitted by a UE2 to a UEn. The UE1 is the Target UE, and UE2 to UEn are the Anchor UE. It can be assumed that involved UE are in-coverage and served by the same gNB.

Step 0: The AMF receives a request for the current absolute location of UE1 from an external LCS client. The external LCS client is not shown in the procedure 800.

Step 1: Based on the requested LCS QoS in the LCS service request the AMF initiates SL positioning and sends an SL-MT-LR request to UE1.

Step 2: Based on the received SL-MT-LR request the UE1 initiates SL discovery procedure and attempts to discover other UE, e.g. UE2 to UEn.

Step 3: Upon discovery of UE2 to UEn the UE1 obtains their SL positioning capabilities, e.g., the supported SL positioning modes, positioning methods, UE role (e.g. Anchor UE) and their configured (if any) SL PRS resource pools.

Step 4: The UE1 sends the SL-MT-LR response to AMF that contains the information about the discovered UE2 to UEn and their SL positioning capabilities and (pre-) configured (if any) SL PRS resource pools. The AMF forwards the SL-MT-LR response to LMF.

Step 5: The LMF triggers SL positioning procedure for the UE1 and the discovered UE2 to UEn. Based on the received SL-MT-LR response the LMF decides to perform UE-assisted positioning based on SL-TDOA and the UE2 to UEn as Anchor UE for determining UE1 location. Furthermore, during the procedure the LMF sends SL positioning assistance data to UE1 to UEn. The assistance data to UE1 includes information about the SL PRS resources that can be requested from each UE2 to UEn. The assistance data to each UE2 to UEn includes information about the SL PRS resources that are requested to be transmitted to UE1. In accordance with the received assistance data the UE1 to UEn perform SL positioning for SL-TDOA. The UE1 performs SL PRS measurements based on the received SL PRS from UE2 to UEn and sends the measured results to the LMF.

Step 6: Based on the SL PRS measurements received from UE1 the LMF then calculates the absolute location of UE1 and sends the location estimate to AMF.

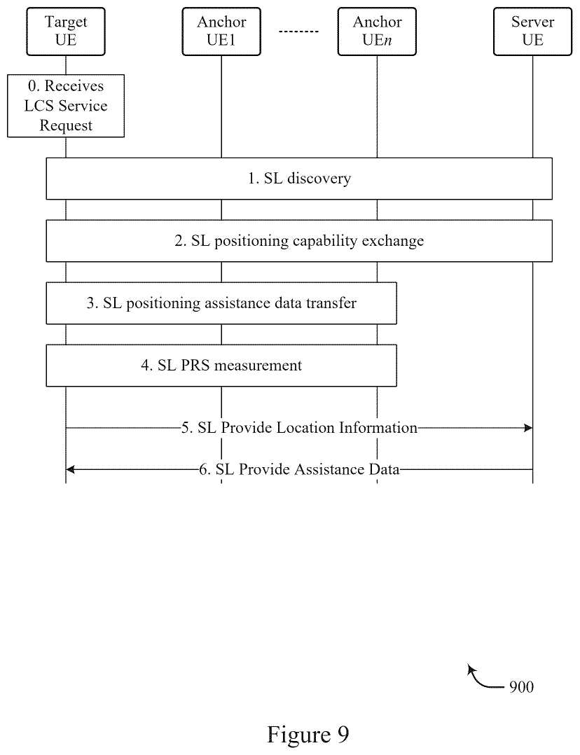

FIG. 9 illustrates an example procedure 900 for UE-only based SL positioning. The procedure 900, for instance, illustrates an example message flow for an SL-MO-LR procedure where the network is not involved and in which the absolute location of the Target UE is to be determined by using SL PRS that is transmitted by the Anchor UE to UEn. In the procedure 900 it can be assumed that all involved UE are out-of-coverage and the Target UE has no SL positioning server functionalities, e.g., it is not able to perform location calculation.

Step 0: The Target UE receives a request for its current absolute location from an external LCS client.

Step 1: Based on the requested LCS QoS in the LCS service request the Target UE initiates SL positioning and starts the SL discovery procedure to discover Anchor and Server UE in its vicinity. It is assumed that the Target UE was able to discover the Anchor UE1 to UEn and one Server UE.

Step 2: The Target UE, Anchor UE1 to UEn and Server UE perform SL positioning capability exchange. For instance, the Target UE obtains the SL positioning capabilities of Anchor UE1 to UEn and Server UE, e.g., supported SL positioning modes, positioning procedures, preconfigured SL PRS resource pools, etc.

Step 3: Based on the result of the SL positioning capability exchange in Step 2, the Target UE decides to perform UE-assisted positioning based on SL-TDOA and to use the Server UE for performing the location calculation. The Target UE then sends SL positioning assistance data to the Anchor UE. The assistance data to each Anchor UE1 to UEn includes information about the SL PRS resources that are requested to be transmitted to the Target UE.

Step 4: The Anchor UE transmit SL PRS in accordance with the received assistance data and the Target UE performs SL PRS measurements based on the received SL PRS from the Anchor UE.

Step 5: The Target UE sends the measured results to the Server UE using the SL Provide Location Information message.

Step 6: Based on the SL PRS measurements received from the Target UE the Server UE then calculates the absolute location of Target UE and sends the location estimate back using the SL Provide Assistance Data message.

The following non-limiting terms can be used to refer to roles of particular UE and/or devices participating in an SL positioning session:

Initiator Device: can initiate an SL positioning/ranging session, and may be a network entity, (e.g. gNB, LMF) or UE/roadside unit (RSU).\

Responder Device: can respond to an SL positioning/ranging session from an initiator device, may be a network entity, (e.g. gNB, LMF) or UE/roadside unit (RSU).

Target UE: Can represent a UE of interest whose position (e.g., absolute and/or relative) is to be obtained by the network or by the target UE itself.

Sidelink positioning: Can refer to positioning of a UE using reference signals transmitted over SL (e.g., PC5 interface) to obtain absolute position, relative position, or ranging information.

Ranging: Can refer to the determination of the distance and/or the direction between a UE and another entity, e.g., an Anchor UE.

Anchor UE: Can refer to a UE supporting positioning of Target UE (e.g. by transmitting and/or receiving reference signals for positioning, providing positioning-related information, etc.) over the PC5 interface and also may be referred to as SL Reference UE.

Assistant UE: Can refer to a UE supporting Ranging/Sidelink between an SL Reference UE and Target UE over PC5, when the direct Ranging/Sidelink positioning between the SL Reference UE/Anchor UE and the Target UE cannot be supported. The measurement/results of the Ranging/Sidelink Positioning between the Assistant UE and the SL Reference UE and that between the Assistant UE and the Target UE can be determined and used to derive the Ranging/Sidelink Positioning results between Target UE and SL Reference UE.

SL Positioning Server UE: Can refer to a UE offering location calculation for SL Positioning and Ranging based service. The SL positioning server UE can interact with other UE over PC5 to calculate the location of a Target UE. A target UE and/or SL Reference UE can act as SL Positioning Server UE.

SL Positioning Client UE: A third-party UE (e.g., other than SL Reference UE and Target UE) which initiates Ranging/Sidelink positioning service request on behalf of an application.

Accordingly, the present disclosure provides techniques to improve procedures for discovery and selection of anchor UE and server UE, such as part of a SL positioning session.

For instance, for discovery and selection of anchor UE in network-based SL positioning operation scenarios, both Target UE and an LMF can maintain a set of active Anchor UE associated to an ongoing SL positioning session. The size of the set may be N, e.g. 4, 8, 16, 32. The value N may be set according to a maximum number of SL connections that can be supported by the Target UE. The active Anchor UE can refer to the Anchor UE which are involved in SL positioning for the Target UE. SLPP messages can be defined for exchanging information related to the Active Anchor UE set:

Active Anchor UE Set Config: This message can be sent by the Target UE to the LMF and include the current list of Anchor UE which are involved in the ongoing SL positioning session for the Target UE. The Target UE may send this message in an unsolicited manner (e.g., when the set of active Anchor UE changes) or in solicited manner. For each active Anchor UE given in the message, the following additional information may be provided by the Target UE: Application layer ID, supported UE role, coverage status (in-coverage, out-of-coverage), mobility status (stationary, low/medium/high mobility as determined e.g. by UE sensors), serving network status with respect to support of SL positioning, Anchor UE location information, PLMN information, L2 Source/Destination ID, line of sight (LOS)/non-LOS (NLOS) indication, positioning session ID, synchronization reference (sync reference UE, GNSS, gNB or UE internal clock).

Active Anchor UE Set Request: This message can be used by the LMF to request the Target UE to send the current list of Anchor UE which are involved in the ongoing SL positioning session for the Target UE.

Alternatively, the information related to the Active Anchor UE set may be included in existing SLPP messages.

In implementations as a response to the Active Anchor UE Set Config message received from the Target UE, the LMF may send a pre-selected set of candidate Anchor UE to the Target UE. This information may be sent using the SLPP Provide Assistance Data message. The LMF may decide to send this information, such as when the number of active Anchor UE falls below a threshold or when the location estimate as calculated by the measurements received from the Target UE does not meet the requested LCS QoS. The LMF may compile this pre-selected set based on information received from the Target UE, the AMF (e.g., information about registered SL positioning capable UE and their SL positioning capabilities) and based on UE subscription information.

In implementations upon reception of the pre-selected set of candidate Anchor UE the Target UE may initiate SL discovery and SL connection establishment with the set of candidate Anchor UE. The Target UE can make a selection of the Anchor UE for SL positioning. According to the order of occurrence of the Anchor UE in the set (e.g., either given by a priority or ranking) the Target UE can select an Anchor UE with which it can successfully establish an SL connection.

In implementations each candidate Anchor UE in the set may be associated with a priority (e.g., given by an explicit priority indicator such as with a value range of 1 to 16 with value 1 indicating the highest priority and value 16 indicating the lowest priority) and/or given by the order of occurrence, e.g., the first listed Anchor UE has the highest priority, the second listed Anchor UE has the second-highest priority, and so on.

Alternatively or additionally if no priority is associated with each candidate Anchor UE in the set, the Target UE may measure the RSRP for each candidate Anchor UE in the set and perform ranking based on the measured results, e.g., based on Anchor UE physical sidelink control channel (PSCCH)-RSRP or physical sidelink broadcast channel (PSBCH)-RSRP.

In implementations both a Target UE and LMF may also maintain a set of inactive Anchor UE, e.g., Anchor UE that were discovered but are currently not involved in any SL positioning operation. The size of the set may be M, e.g., 4, 8, 16, 32, 64. The Target UE may use this information when a new Anchor UE discovery and selection process is to be initiated for the ongoing SL positioning session. The LMF may use this information for sending a pre-selected set of candidate Anchor UE to the Target UE.

In implementations information stored about inactive Anchor UE may be sent by the Target UE to the LMF or vice versa by using existing SLPP messages, e.g., the SLPP Provide Assistance Data message. For each inactive Anchor UE the following additional information may be provided: Application layer ID, supported UE role, coverage status (in-coverage, out-of-coverage), mobility status (stationary, low/medium/high mobility as determined e.g. by UE sensors), serving network status with respect to support of SL positioning, Anchor UE location information, PLMN information, L2 Source/Destination ID, LOS/NLOS indication, synchronization reference (sync reference UE, GNSS, gNB or UE internal clock).

In implementations for UE-only based SL positioning operation scenarios, for scenarios of a separate Server UE, both Target UE and Server UE may maintain a set of active Anchor UE and a set of inactive Anchor UE. Aspects for using the set of active Anchor UE and the set of inactive Anchor UE as described above for network-based SL positioning operation scenarios can also apply in such scenarios.

Implementations described in this disclosure also enable discovery and selection of Server UE. For instance, in network-based SL positioning operation scenarios the SL positioning capable LMF may decide to offload the location calculation to a separate Server UE, e.g., due to load reasons. In such scenarios the LMF and Target UE may perform the following steps:

In implementations the Target UE can send to LMF a list of discovered Server UE and based on the received information and other information the LMF can pre-select a set of candidate Server UE and the LMF can send this set to the Target UE. Other information, for instance, represents information about registered SL positioning capable UE and their SL positioning capabilities, e.g., whether SL positioning capable UE support Server UE functionality. The LMF may receive such information from the AMF. Other information may also include subscription information of the concerned UE.

In implementations a size of the set of candidate Server UE may be L, e.g. 2, 4, 8, etc. Each candidate Server UE in the set may be associated with a priority, e.g. given by an explicit priority indicator (e.g. with a value range of 1 to 16 with value 1 indicating the highest priority and value 16 indicating the lowest priority) and/or given by the order of occurrence in the set, e.g., the first listed Server UE has the highest priority, the second listed Server UE has the second-highest priority, and so on.

Alternatively, if no priority is associated with each candidate Server UE in the set, the Target UE may measure (e.g. the RSRP) for each candidate Server UE in the set and perform ranking based on the measured results, e.g., based on Server UE PSCCH-RSRP, PSBCH-RSRP, etc. The pre-selected set of candidate Server UE may be sent by the LMF in a new SLPP message Candidate Server UE Set Config. Alternatively, this information may be sent in an existing SLPP message.

Upon reception of the set of candidate Server UE, the Target UE can make a selection of Server UE for SL positioning. According to the order of occurrence of the Server UE in the set (e.g., given by a priority or ranking) the Target UE can select the first Server UE with which it can successfully establish an SL connection and sends then a message back to inform the LMF about the selected Server UE. This message may be a new and/or an existing SLPP message.

In implementations if during an ongoing SL positioning session the established SL connection with the selected Server UE drops the Target UE can perform Server UE reselection based on the stored set of candidate Server UE. Further, both Target UE and LMF can maintain the set of candidate Server UE. During an ongoing SL positioning session the LMF may make and send updates of the candidate Server UE set to the Target UE by using the Candidate Server UE Set Config message.

Thus, advantages of the proposed solutions include that frequent initiation of Anchor UE and Server UE discovery and selection process during an ongoing SL positioning session can be reduced; delay for performing SL positioning and potential degradation in the performance of location estimation can be reduced; and additional signaling overhead for Anchor UE and Server UE discovery and selection process during an ongoing SL positioning session can be reduced.

According to aspects pertaining to discovery and selection of anchor UE, network-based SL positioning operation scenarios where an SL-MT-LR procedure is performed and in which the absolute location of Target UE1 (e.g., as an extension of the procedure 800) can be determined by using SL PRS that is transmitted by Anchor UE2 to UEn. Further, an LMF response received from UE1 the SL-MT-LR can include information about the discovered UE2 to UEn and their SL positioning capabilities and configured SL PRS resource pools.

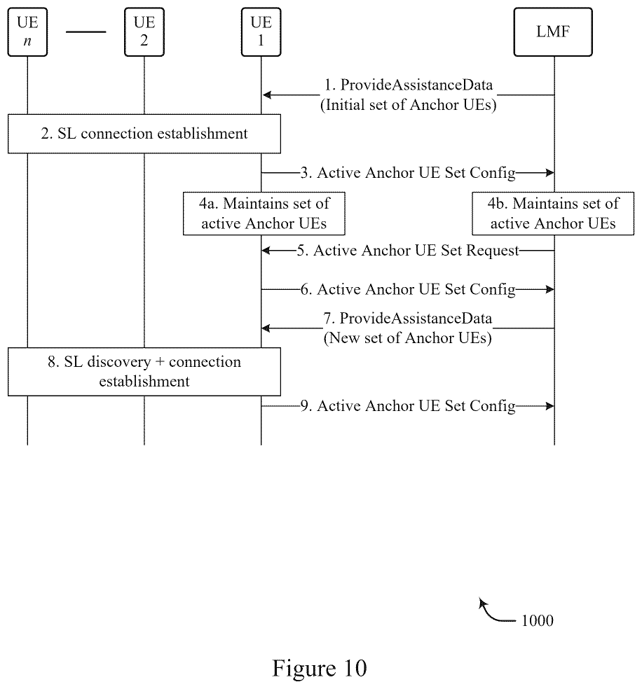

FIG. 10 illustrates an example procedure 1000 in accordance with aspects of the present disclosure.

Step 1: In accordance with the information received from UE1 the LMF can compile and send an initial set of Anchor UE (e.g., with n=7) with which UE1 can perform SL positioning.

Step 2: Based on the information received from the LMF, UE1 can start to establish an SL connection with the Anchor UE2 to UE7. The UE1, for instance, was able to establish an SL connection with the Anchor UE2, UE4, UE5 and UE6. UE1 can select the Anchor UE2, UE4, UE5, UE6 and start SL positioning with an Anchor UE, not expressly illustrated in FIG. 10.

Step 3: The UE1 can send to the LMF the Active Anchor UE Set Config message that includes the set of Anchor UE with which the UE1 can perform SL positioning.

Step 4a: The UE1 can maintain the set of active Anchor UE that includes UE2, UE4, UE5, and UE6 such as in accordance with the message sent in Step 3.

Step 4b: The LMF maintains the set of active Anchor UE that includes UE2, UE4, UE5 and UE6 such as in accordance with the message received in Step 3.

Step 5: The LMF can send the Active Anchor UE Set Request message to request the UE1 to send the current set of active Anchor UE.

Step 6: The UE1 can send the current set of active Anchor UE to LMF by using the Active Anchor UE Set Config message. In implementations such as due to mobility the current set of active Anchor UE may only include UE2 and UE5.

Step 7: When the number of active Anchor UE falls below a threshold (e.g., threshold of 4 such as set internally by LMF based on the requested LCS QoS) the LMF can send a new set of Anchor UE (UE8 to UE12) with which UE1 can perform SL positioning.

Step 8: Based on the information received from the LMF, UE1 can start to discover and to establish an SL connection with the Anchor UE8 to UE12. The UE1, for instance, was able to establish an SL connection with the Anchor UE9, UE10, UE11. UE1 can select the Anchor UE9, UE10, UE11 and start SL positioning with an Anchor UE.

Step 9: The UE1 can send a most recent set of active Anchor UE to the LMF by using the Active Anchor UE Set Config message. The latest set of active Anchor UE can include UE2, UE5, UE9, UE10, and UE11.

Implementations also enable discovery and selection of server UE. For instance, network-based SL positioning operations (e.g., as described in example procedure 800) where an SL-MT-LR procedure is performed and in which the absolute location of Target UE1 can be determined using SL PRS that is transmitted by Anchor UE2 to UEn. Further, UE-assisted positioning can be performed to determine the location of the Target UE1, e.g., where the Target UE1 has no server UE functionality. Further, such as due to load reasons the SL positioning capable LMF can decide to offload the location calculation to a separate Server UE. Thus, the LMF can request that the Target UE1 send a list of discovered Server UE.

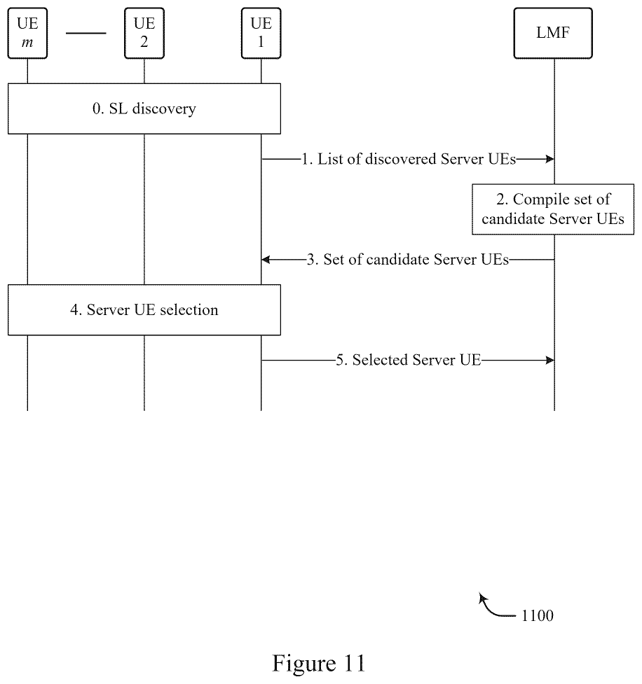

FIG. 11 illustrates an example procedure 1100 in accordance with aspects of the present disclosure.

Step 0: Based on the request from LMF the UE1 can perform SL discovery to discover a Server UE. The UE1, for instance, discovers the Server UE2 to UEm with m=8.

Step 1: UE1 can send to the LMF the list of discovered Server UE.

Step 2: Based on the received information from UE1 and other information the LMF can compile a set of candidate Server UE and send this set to UE1. The set of candidate Server UE can include 4 UE (UE2 to UE5) and each UE can be associated with an explicit priority value as follows: UE2: Priority value “1”; UE3: Priority value “2”; UE4: Priority value “3”; UE5: Priority value “4”.

Step 3: LMF sends the set of candidate Server UE to UE1.

Step 4: Based at least in part on reception of the set of candidate Server UE, UE1 can select a Server UE for SL positioning. For instance, according to a priority value for each Server UE, UE1 can start to establish an SL connection with UE2. The SL connection establishment with UE2 can fails. Therefore, UE1 can start to establish an SL connection with UE3. A SL connection with UE3 can be successfully established. Therefore, UE1 can select UE3 as a Server UE.

Step 5: UE1 can inform the LMF about the selected Server UE3.

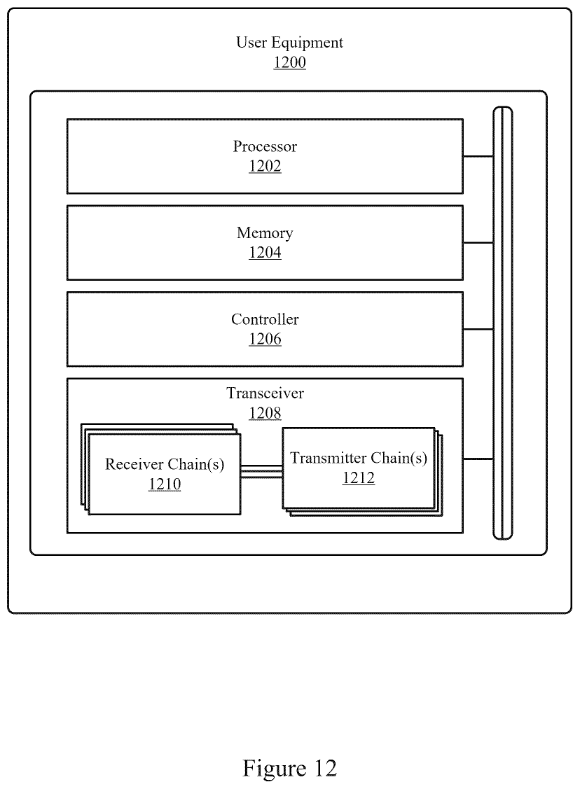

FIG. 12 illustrates an example of a UE 1200 in accordance with aspects of the present disclosure. The UE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the UE 1200 to perform various functions of the present disclosure.

The memory 1204 may include volatile or non-volatile memory. The memory 1204 may store computer-readable, computer-executable code including instructions when executed by the processor 1202 cause the UE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the UE 1200 to perform one or more of the functions described herein (e.g., executing, by the processor 1202, instructions stored in the memory 1204). For example, the processor 1202 may support wireless communication at the UE 1200 in accordance with examples as disclosed herein. The UE 1200 may be configured to or operable to support a means for receiving, from a first apparatus, a first sidelink positioning protocol message including information for selecting a first set of one or more second apparatus for sidelink positioning; selecting, from the first set of one or more second apparatus, a subset of the one or more second apparatus for sidelink positioning; and transmitting, to the first apparatus, a second sidelink positioning protocol message including information pertaining to the subset of the one or more second apparatus.

Additionally, the UE 1200 may be configured to support any one or combination of selecting the subset of the one or more second apparatus based at least in part on a determination that a sidelink connection with the subset of the one or more second apparatus is able to be established; the information pertaining to the subset of the one or more second apparatus includes a priority value; determining whether a sidelink connection with the one or more second apparatus is able to be established based at least in part on the priority value; selecting the subset of the one or more second apparatus for sidelink positioning includes: determining that a sidelink connection drops to a first candidate apparatus of the first set of the one or more second apparatus; and performing a reselection of a second candidate apparatus of the first set of the one or more second apparatus; maintaining the selected subset of the one or more second apparatus for sidelink positioning operation; the UE includes a sidelink target UE; the first apparatus includes one or more of a sidelink server UE or a location management function; the subset of the one or more second apparatus includes one or more of a sidelink anchor UE or a sidelink server UE; maintaining a set of inactive sidelink anchor UE that are not currently involved in a sidelink positioning operation; selecting the subset of the one or more second apparatus for sidelink positioning based at least in part on the set of inactive sidelink anchor UE.

Additionally, or alternatively, the UE 1200 may support functionality to receive, from a first apparatus, a first sidelink positioning protocol message including information for selecting a first set of one or more second apparatus for sidelink positioning; select, from the first set of one or more second apparatus, a subset of the one or more second apparatus for sidelink positioning; and transmit, to the first apparatus, a second sidelink positioning protocol message including information pertaining to the subset of the one or more second apparatus.

Additionally, the UE 1200 may be configured to support any one or combination of where the at least one processor is configured to cause the UE to select the subset of the one or more second apparatus based at least in part on a determination that a sidelink connection with the subset of the one or more second apparatus is able to be established; the information pertaining to the subset of the one or more second apparatus includes a priority value; the at least one processor is configured to cause the UE to determine whether a sidelink connection with the one or more second apparatus is able to be established based at least in part on the priority value; to select the subset of the one or more second apparatus for sidelink positioning, the at least one processor is configured to cause the UE to: determine that a sidelink connection drops to a first candidate apparatus of the first set of the one or more second apparatus; and perform a reselection of a second candidate apparatus of the first set of the one or more second apparatus; the at least one processor is configured to cause the UE to maintain the selected subset of the one or more second apparatus for sidelink positioning operation; the UE includes a sidelink target UE; the first apparatus includes one or more of a sidelink server UE or a location management function; the subset of the one or more second apparatus includes one or more of a sidelink anchor UE or a sidelink server UE; the at least one processor is configured to cause the UE to maintain a set of inactive sidelink anchor UE that are not currently involved in a sidelink positioning operation; the at least one processor is configured to cause the UE to select the subset of the one or more second apparatus for sidelink positioning based at least in part on the set of inactive sidelink anchor UE.

In some implementations, the processor 1202 and the memory 1204 coupled with the processor 1202 may be configured to cause the UE 1200 to perform one or more of the functions described herein (e.g., executing, by the processor 1202, instructions stored in the memory 1204). For example, the processor 1202 may support wireless communication at the UE 1200 in accordance with examples as disclosed herein. The UE 1200 may be configured to or operable to support a means for transmitting, to a second UE, a first sidelink positioning protocol message including information for selecting a first set of one or more apparatus for sidelink positioning of the second UE; and receiving, from the second UE, a second sidelink positioning protocol message including information pertaining to a subset of the one or more apparatus.

Additionally, the UE 1200 may be configured to support any one or combination of where the information pertaining to the subset of the one or more apparatus includes a priority value; the second UE includes a sidelink target UE; the first UE includes a sidelink server UE.

Additionally, or alternatively, the UE 1200 may support functionality to transmit, to a second UE, a first sidelink positioning protocol message including information for selecting a first set of one or more apparatus for sidelink positioning of the second UE; and receive, from the second UE, a second sidelink positioning protocol message including information pertaining to a subset of the one or more apparatus.

Additionally, the UE 1200 may be configured to support any one or combination of where the information pertaining to the subset of the one or more apparatus includes a priority value; the second UE includes a sidelink target UE; the first UE includes a sidelink server UE.

The controller 1206 may manage input and output signals for the UE 1200. The controller 1206 may also manage peripherals not integrated into the UE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the UE 1200 may include at least one transceiver 1208. In some other implementations, the UE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

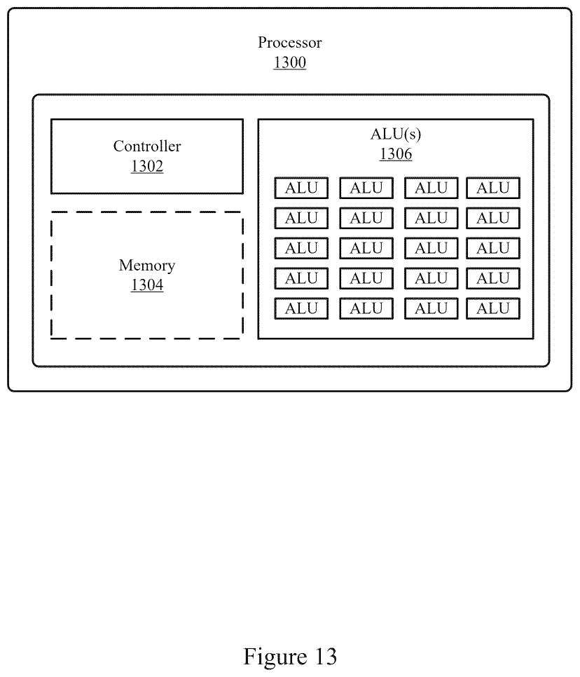

FIG. 13 illustrates an example of a processor 1300 in accordance with aspects of the present disclosure. The processor 1300 may be an example of a processor configured to perform various operations in accordance with examples as described herein. The processor 1300 may include a controller 1302 configured to perform various operations in accordance with examples as described herein. The processor 1300 may optionally include at least one memory 1304, which may be, for example, an L1/L2/L3 cache. Additionally, or alternatively, the processor 1300 may optionally include one or more arithmetic-logic units (ALUs) 1306. One or more of these components may be in electronic communication or otherwise coupled (e.g., operatively, communicatively, functionally, electronically, electrically) via one or more interfaces (e.g., buses).

The processor 1300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1302 may be configured to manage and coordinate various operations (e.g., signaling, receiving, obtaining, retrieving, transmitting, outputting, forwarding, storing, determining, identifying, accessing, writing, reading) of the processor 1300 to cause the processor 1300 to support various operations in accordance with examples as described herein. For example, the controller 1302 may operate as a control unit of the processor 1300, generating control signals that manage the operation of various components of the processor 1300. These control signals include enabling or disabling functional units, selecting data paths, initiating memory access, and coordinating timing of operations.

The controller 1302 may be configured to fetch (e.g., obtain, retrieve, receive) instructions from the memory 1304 and determine subsequent instruction(s) to be executed to cause the processor 1300 to support various operations in accordance with examples as described herein. The controller 1302 may be configured to track memory addresses of instructions associated with the memory 1304. The controller 1302 may be configured to decode instructions to determine the operation to be performed and the operands involved. For example, the controller 1302 may be configured to interpret the instruction and determine control signals to be output to other components of the processor 1300 to cause the processor 1300 to support various operations in accordance with examples as described herein. Additionally, or alternatively, the controller 1302 may be configured to manage flow of data within the processor 1300. The controller 1302 may be configured to control transfer of data between registers, ALUs 1306, and other functional units of the processor 1300.

The memory 1304 may include one or more caches (e.g., memory local to or included in the processor 1300 or other memory, such as RAM, ROM, DRAM, SDRAM, SRAM, MRAM, flash memory, etc. In some implementations, the memory 1304 may reside within or on a processor chipset (e.g., local to the processor 1300). In some other implementations, the memory 1304 may reside external to the processor chipset (e.g., remote to the processor 1300).

The memory 1304 may store computer-readable, computer-executable code including instructions that, when executed by the processor 1300, cause the processor 1300 to perform various functions described herein. The code may be stored in a non-transitory computer-readable medium such as system memory or another type of memory. The controller 1302 and/or the processor 1300 may be configured to execute computer-readable instructions stored in the memory 1304 to cause the processor 1300 to perform various functions. For example, the processor 1300 and/or the controller 1302 may be coupled with or to the memory 1304, the processor 1300, and the controller 1302, and may be configured to perform various functions described herein. In some examples, the processor 1300 may include multiple processors and the memory 1304 may include multiple memories. One or more of the multiple processors may be coupled with one or more of the multiple memories, which may, individually or collectively, be configured to perform various functions herein.

The one or more ALUs 1306 may be configured to support various operations in accordance with examples as described herein. In some implementations, the one or more ALUs 1306 may reside within or on a processor chipset (e.g., the processor 1300). In some other implementations, the one or more ALUs 1306 may reside external to the processor chipset (e.g., the processor 1300). One or more ALUs 1306 may perform one or more computations such as addition, subtraction, multiplication, and division on data. For example, one or more ALUs 1306 may receive input operands and an operation code, which determines an operation to be executed. One or more ALUs 1306 may be configured with a variety of logical and arithmetic circuits, including adders, subtractors, shifters, and logic gates, to process and manipulate the data according to the operation. Additionally, or alternatively, the one or more ALUs 1306 may support logical operations such as AND, OR, exclusive-OR (XOR), not-OR (NOR), and not-AND (NAND), enabling the one or more ALUs 1306 to handle conditional operations, comparisons, and bitwise operations.

The processor 1300 may support wireless communication in accordance with examples as disclosed herein. The processor 1300 may be configured to or operable to receive, from a first apparatus, a first sidelink positioning protocol message including information for selecting a first set of one or more second apparatus for sidelink positioning; select, from the first set of one or more second apparatus, a subset of the one or more second apparatus for sidelink positioning; and transmit, to the first apparatus, a second sidelink positioning protocol message including information pertaining to the subset of the one or more second apparatus.

Additionally, the processor 1300 may be configured to support any one or combination of where the at least one controller is configured to cause the processor to select the subset of the one or more second apparatus based at least in part on a determination that a sidelink connection with the subset of the one or more second apparatus is able to be established; the information pertaining to the subset of the one or more second apparatus includes a priority value; the at least one controller is configured to cause the processor to determine whether a sidelink connection with the one or more second apparatus is able to be established based at least in part on the priority value; to select the subset of the one or more second apparatus for sidelink positioning, the at least one controller is configured to cause the processor to: determine that a sidelink connection drops to a first candidate apparatus of the first set of the one or more second apparatus; and perform a reselection of a second candidate apparatus of the first set of the one or more second apparatus; the at least one controller is configured to cause the processor to maintain the selected subset of the one or more second apparatus for sidelink positioning operation; the processor is implemented as part of a sidelink target UE; the first apparatus includes one or more of a sidelink server UE or a location management function; the subset of the one or more second apparatus includes one or more of a sidelink anchor UE or a sidelink server UE; the at least one controller is configured to cause the processor to maintain a set of inactive sidelink anchor UE that are not currently involved in a sidelink positioning operation; the at least one controller is configured to cause the processor to select the subset of the one or more second apparatus for sidelink positioning based at least in part on the set of inactive sidelink anchor UE.

The processor 1300 may support wireless communication in accordance with examples as disclosed herein. The processor 1300 may be configured to or operable to transmit, to a first UE, a first sidelink positioning protocol message including information for selecting a first set of one or more apparatus for sidelink positioning of a second UE; and receive, from the first UE, a second sidelink positioning protocol message including information pertaining to a subset of the one or more apparatus.

Additionally, the processor 1300 may be configured to support any one or combination of where the information pertaining to the subset of the one or more apparatus includes a priority value; the first UE includes a sidelink target UE; the processor is implemented as part of a sidelink server UE.

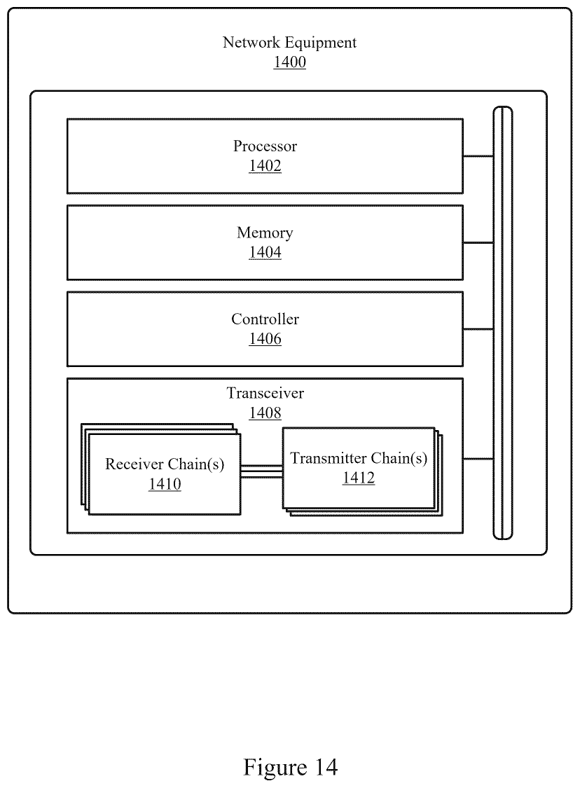

FIG. 14 illustrates an example of a NE 1400 in accordance with aspects of the present disclosure. The NE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the NE 1400 to perform various functions of the present disclosure.

The memory 1404 may include volatile or non-volatile memory. The memory 1404 may store computer-readable, computer-executable code including instructions when executed by the processor 1402 cause the NE 1400 to perform various functions described herein. The code may be stored in a non-transitory computer-readable medium such as the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the NE 1400 to perform one or more of the functions described herein (e.g., executing, by the processor 1402, instructions stored in the memory 1404). For example, the processor 1402 may support wireless communication at the NE 1400 in accordance with examples as disclosed herein. The NE 1400 may be configured to or operable to support a means for transmitting, to a first UE, a first sidelink positioning protocol message including information for selecting a first set of one or more second UE for sidelink positioning of the first UE; and receiving, from the first UE, a second sidelink positioning protocol message including information pertaining to a subset of the one or more second UE.

Additionally, the NE 1400 may be configured to support any one or combination of where the information pertaining to the subset of the one or more second UE includes a priority value; the network entity includes a location management function; the subset of the one or more second UE includes one or more of a sidelink anchor UE or a sidelink server UE; maintaining a set of inactive sidelink anchor UE that are not currently involved in a sidelink positioning operation.

Additionally, or alternatively, the NE 1400 may support functionality to transmit, to a first UE, a first sidelink positioning protocol message including information for selecting a first set of one or more second UE for sidelink positioning of the first UE; and receive, from the first UE, a second sidelink positioning protocol message including information pertaining to a subset of the one or more second UE.

Additionally, the NE 1400 may be configured to support any one or combination of where the information pertaining to the subset of the one or more second UE includes a priority value; the network entity includes a location management function; the subset of the one or more second UE includes one or more of a sidelink anchor UE or a sidelink server UE; to maintain a set of inactive sidelink anchor UE that are not currently involved in a sidelink positioning operation.

the information pertaining to the subset of the one or more second UE includes a priority value; the network entity includes a location management function; the subset of the one or more second UE includes one or more of a sidelink anchor UE or a sidelink server UE; the at least one processor is configured to cause the network entity to maintain a set of inactive sidelink anchor UE that are not currently involved in a sidelink positioning operation.

The controller 1406 may manage input and output signals for the NE 1400. The controller 1406 may also manage peripherals not integrated into the NE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the NE 1400 may include at least one transceiver 1408. In some other implementations, the NE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas to receive a signal over the air or wireless medium. The receiver chain 1410 may include at least one amplifier (e.g., a low-noise amplifier (LNA)) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

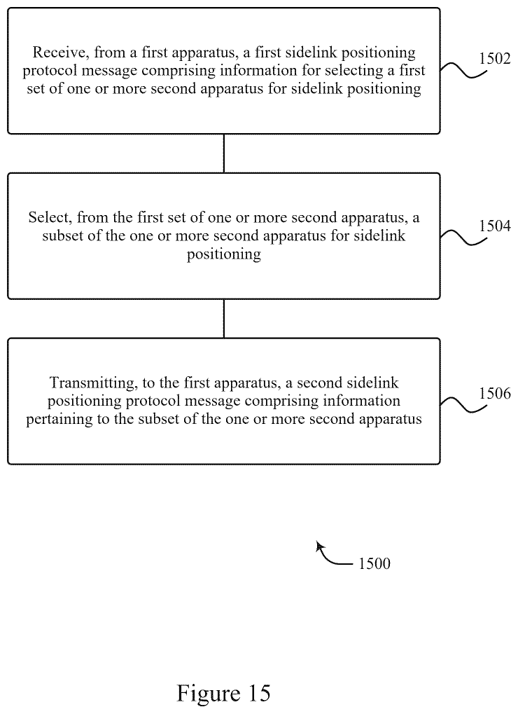

FIG. 15 illustrates a flowchart of a method 1500 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1502, the method may include receiving, from a first apparatus, a first sidelink positioning protocol message comprising information for selecting a first set of one or more second apparatus for sidelink positioning. The operations of 1502 may be performed in accordance with examples as described herein. In some implementations, aspects of the operations of 1502 may be performed by a UE as described with reference to FIG. 12.

At 1504, the method may include selecting, from the first set of one or more second apparatus, a subset of the one or more second apparatus for sidelink positioning. The operations of 1504 may be performed in accordance with examples as described herein. In some implementations, aspects of the operations of 1504 may be performed by a UE as described with reference to FIG. 12.

At 1506, the method may include transmitting, to the first apparatus, a second sidelink positioning protocol message comprising information pertaining to the subset of the one or more second apparatus. The operations of 1506 may be performed in accordance with examples as described herein. In some implementations, aspects of the operations of 1506 may be performed a UE as described with reference to FIG. 12.

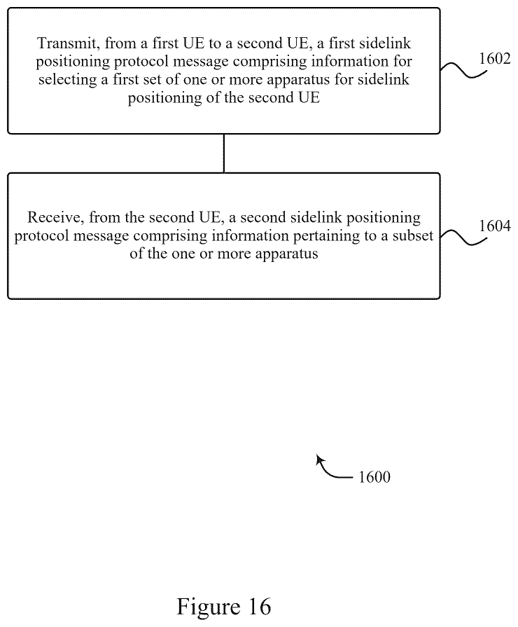

FIG. 16 illustrates a flowchart of a method 1600 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1602, the method may include transmitting, from a first UE to a second UE, a first sidelink positioning protocol message comprising information for selecting a first set of one or more apparatus for sidelink positioning of the second UE. The operations of 1602 may be performed in accordance with examples as described herein. In some implementations, aspects of the operations of 1602 may be performed by a UE as described with reference to FIG. 12.

At 1604, the method may include receiving, from the second UE, a second sidelink positioning protocol message comprising information pertaining to a subset of the one or more apparatus. The operations of 1604 may be performed in accordance with examples as described herein. In some implementations, aspects of the operations of 1604 may be performed by a UE as described with reference to FIG. 12.

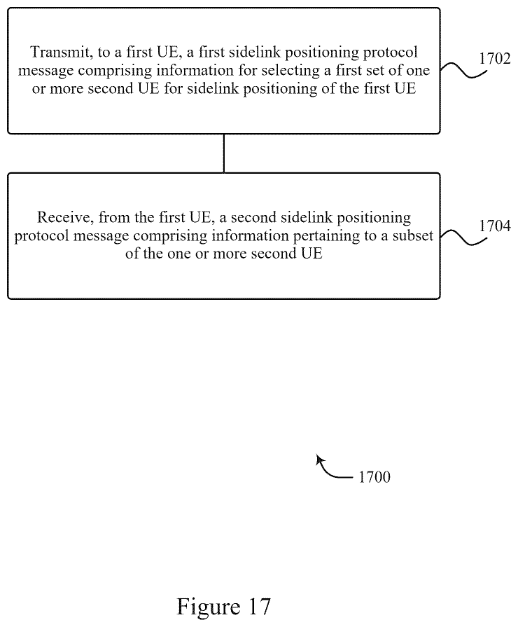

FIG. 17 illustrates a flowchart of a method 1700 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1702, the method may include transmitting, to a first UE a first sidelink positioning protocol message comprising information for selecting a first set of one or more second UE for sidelink positioning of the first UE. The operations of 1702 may be performed in accordance with examples as described herein. In some implementations, aspects of the operations of 1702 may be performed by a NE as described with reference to FIG. 14.

At 1704, the method may include receiving, from the first UE, a second sidelink positioning protocol message comprising information pertaining to a subset of the one or more second UE. The operations of 1704 may be performed in accordance with examples as described herein. In some implementations, aspects of the operations of 1704 may be performed by a NE as described with reference to FIG. 14.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive, from a first apparatus, a first sidelink positioning protocol message comprising information for selecting a first set of one or more second apparatus for sidelink positioning;
select, from the first set of one or more second apparatus, a subset of the one or more second apparatus for sidelink positioning; and
transmit, to the first apparatus, a second sidelink positioning protocol message comprising information pertaining to the subset of the one or more second apparatus.

2. The UE of claim 1, wherein the at least one processor is configured to cause the UE to select the subset of the one or more second apparatus based at least in part on a determination that a sidelink connection with the subset of the one or more second apparatus is able to be established.

3. The UE of claim 1, wherein the information pertaining to the subset of the one or more second apparatus comprises a priority value.

4. The UE of claim 3, wherein the at least one processor is configured to cause the UE to determine whether a sidelink connection with the one or more second apparatus is able to be established based at least in part on the priority value.

5. The UE of claim 1, wherein to select the subset of the one or more second apparatus for sidelink positioning, the at least one processor is configured to cause the UE to:
determine that a sidelink connection drops to a first candidate apparatus of the first set of the one or more second apparatus; and
perform a reselection of a second candidate apparatus of the first set of the one or more second apparatus.

6. The UE of claim 1, wherein the at least one processor is configured to cause the UE to maintain the selected subset of the one or more second apparatus for sidelink positioning operation.

7. The UE of claim 1, wherein the UE comprises a sidelink target UE.

8. The UE of claim 1, wherein the first apparatus comprises one or more of a sidelink server UE or a location management function.

9. The UE of claim 1, wherein the subset of the one or more second apparatus comprises one or more of a sidelink anchor UE or a sidelink server UE.

10. The UE of claim 9, wherein the at least one processor is configured to cause the UE to maintain a set of inactive sidelink anchor UE that are not currently involved in a sidelink positioning operation.

11. The UE of claim 10, wherein the at least one processor is configured to cause the UE to select the subset of the one or more second apparatus for sidelink positioning based at least in part on the set of inactive sidelink anchor UE.

12. A first user equipment (UE) for wireless communication, comprising:
at least one memory; and
at least one processor coupled with the at least one memory and configured to cause the first UE to:
transmit, to a second UE, a first sidelink positioning protocol message comprising information for selecting a first set of one or more apparatus for sidelink positioning of the second UE; and
receive, from the second UE, a second sidelink positioning protocol message comprising information pertaining to a subset of the one or more apparatus.

13. The first UE of claim 12, wherein the information pertaining to the subset of the one or more apparatus comprises a priority value.

14. The first UE of claim 12, wherein the second UE comprises a sidelink target UE.

15. The first UE of claim 12, wherein the first UE comprises a sidelink server UE.

16. A network entity for wireless communication, comprising:
at least one memory; and
at least one processor coupled with the at least one memory and configured to cause the network entity to:
transmit, to a first user equipment (UE), a first sidelink positioning protocol message comprising information for selecting a first set of one or more second UE for sidelink positioning of the first UE; and
receive, from the first UE, a second sidelink positioning protocol message comprising information pertaining to a subset of the one or more second UE.

17. The network entity of claim 16, wherein the information pertaining to the subset of the one or more second UE comprises a priority value.

18. The network entity of claim 16, wherein the subset of the one or more second UE comprises one or more of a sidelink anchor UE or a sidelink server UE.

19. The network entity of claim 18, wherein the at least one processor is configured to cause the network entity to maintain a set of inactive sidelink anchor UE that are not currently involved in a sidelink positioning operation.

20. A processor for wireless communication, comprising:
at least one controller coupled with at least one memory and configured to cause the processor to:
receive, from a first apparatus, a first sidelink positioning protocol message comprising information for selecting a first set of one or more second apparatus for sidelink positioning;
select, from the first set of one or more second apparatus, a subset of the one or more second apparatus for sidelink positioning; and
transmit, to the first apparatus, a second sidelink positioning protocol message comprising information pertaining to the subset of the one or more second apparatus.
